(19) United States
(12) Patent Application Publication
(10) Pub. No.: US 2007/0182263 A1
(43) Pub. Date: Aug. 9, 2007

(54) Hybrid Induction Motor

(76) Inventor: Janai Vargas, Ridgewood, NY (US)

Correspondence Address: MICHAEL I KROLL, 171 STILLWELL LANE, SYOSSET, NY, 11791, US

(21) Appl. No.: 11/625,959

(22) Filed: Jan. 23, 2007

Related U.S. Application Data
(60) Provisional application No. 60/764,664, filed on Feb. 3, 2006.

(51) Int. Cl. H02K 16/02; H02K 17/00; H02K 16/00

(52) U.S. Cl. 310/114; 310/166

(57) ABSTRACT

Disclosed is an induction motor providing a method of increasing a motors revolutions by connecting a plurality of stators and a plurality of rotors in a specific configuration that will result in an increase in RPM's.

### RELATED APPLICATION

This application is subject to provisional application Ser. No. 60/764,664 filed 03 Feb. 2007.

### FIELD OF THE INVENTION

The present invention relates generally to motors and, more specifically, to a method of increasing a motors revolutions by connecting a plurality of stators and a plurality of rotors in a specific configuration that will result in an increase in RPM's.

Induction AC motors consists of two electrical assemblies the stator and rotor. The alternating current supplied to the stator induces current in the rotor creating a rotor magnetic field which will follow the stator rotating field causing rotor rotation.

### DESCRIPTION OF THE PRIOR ART

Other induction motors exist and may be suitable for the purposes for which they were designed, they would not be as suitable for the purposes of the present invention, as hereinafter described.

Therefore it is felt that a need exists for an induction motor that impinges rotor rotation onto at least one other stator thereby increasing the RPM's of the conjoined stator rotor.

### SUMMARY OF THE PRESENT INVENTION

A primary object of the present invention is to provide a hybrid motor having increased RPM.

Another object of the present invention is to provide a hybrid motor comprising a plurality of stators and a plurality of rotors.

Yet another object of the present invention is to provide a hybrid motor wherein a rotor is connected to an adjacent stator to impinge rotation thereof.

Still yet another object of the present invention is to provide a hybrid motor wherein the adjacent stator has a rotor with an additive RPM generated from the rotating stator.

Another object of the present invention is to provide a hybrid motor wherein the number of conjoined stator rotors is a variable of the desired RPM's.

Additional objects of the present invention will appear as the description proceeds.

The present invention overcomes the shortcomings of the prior art by providing a method of increasing a motors revolutions by connecting a plurality of stators and a plurality of rotors in a specific configuration that will result in an increase in RPM's for induction motors by conjoining adjacent stators with adjoining rotors in step fashion.

The foregoing and other objects and advantages will appear from the description to follow. In the description reference is made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is a typical induction motor;

FIG. 2 is a typical induction motor;

FIG. 3 is a typical induction motor;

FIG. 4 is a typical induction motor;

FIG. 5 is the conjoined rotor and stator of the present invention;

FIG. 6 is a view of the present invention's induction motor.

FIG. 7 is a view of the present invention's induction motor;

FIG. 8 is the present invention' induction motor;

FIG. 9 is the present invention's induction motor; and

FIG. 10 is the present invention's induction motor.

### DESCRIPTION OF THE REFERENCED NUMERALS

Turning now descriptively to the drawings, in which similar reference characters denote similar elements throughout the several views, the Figures illustrate the hybrid induction motor of the present invention. With regard to the reference numerals used, the following numbering is used throughout the various drawing Figures.
10 MEI System
12 AC current source
14 AC current
16 stator
18 rotor
flux field
22 motor one stator
24 motor one rotor
26 motor one RPM
28 adjacent stator fixation
30 conjoined stator
32 adjacent rotor
34 induced current of conjoined stator
36 n^{th} stator
38 n^{th} rotor

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

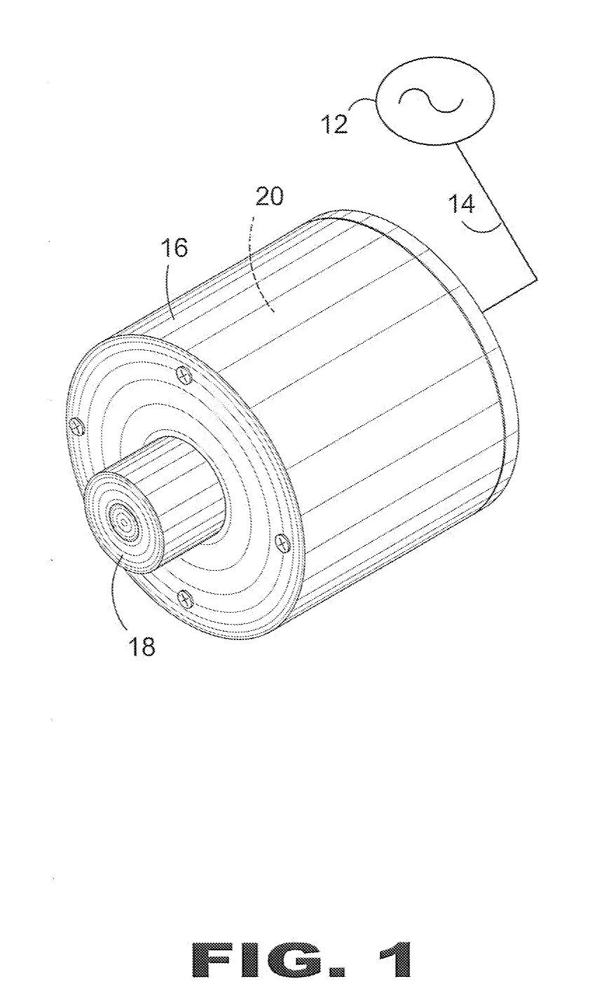

Referring to FIG. 1, shown is a typical induction motor. The motor having a stator 16 supplied with AC power 14 from an AC power source 12 used to create a rotating magnetic field which induces current in the rotor 18 conductors which in turn creates conductor magnetic fields that cut lines of stator magnetic field flux 20 creating the magnetic force driving rotor rotation.

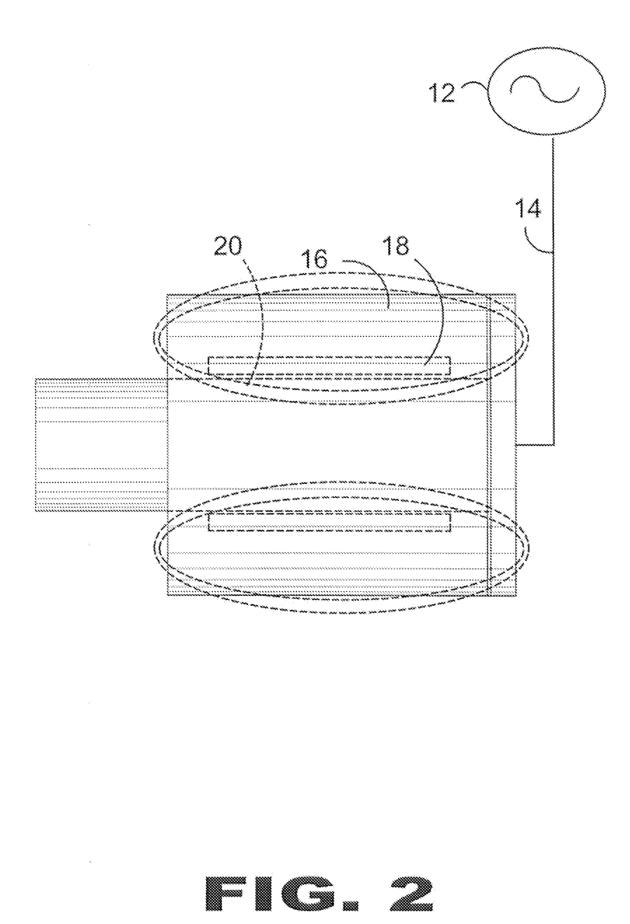

Referring to FIG. 2, shown is a typical induction motor. The motor having a stator 16 comprised of radially positioned electro-magnets that when supplied with AC power 14 from an AC power source 12 are used to create a rotating magnetic field dependant on the number of stator poles and power source frequency which induces current in the rotor 18 conductors which in turn creates conductor magnetic fields that cut lines of stator magnetic field flux 20 creating the magnetic force driving rotor rotation.

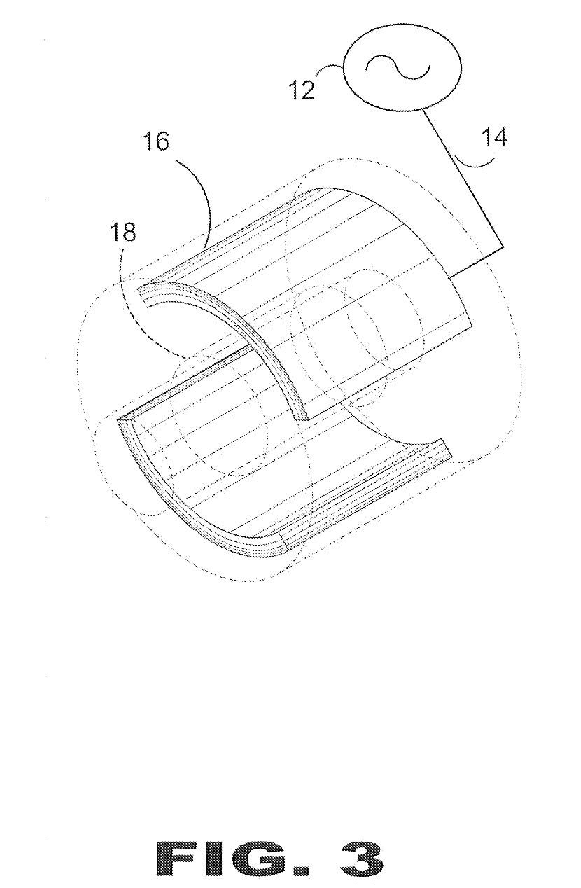

Referring to FIG. 3, shown is a typical induction motor. As aforementioned, the motor having AC power 14 from an AC power source 12 has stator 16 for inducing rotor 18 conductor current and rotor conductor magnetic fields that cut lines of stator magnetic field flux creating the magnetic force driving rotor rotation.

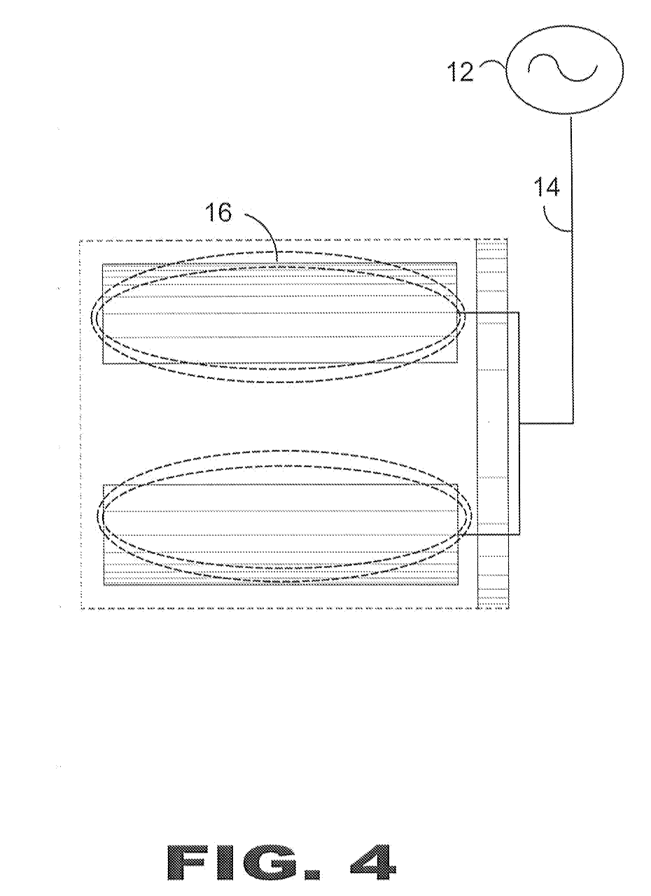

Referring to FIG. 4, shown is a typical induction motor. The motor having AC current 14 via AC power source 12 having stator 16 comprised of radially positioned electro-magnets that when supplied with AC power 14 are used to create a rotating magnetic field which induces current in the rotor 18 conductors which in turn creates conductor magnetic fields that cut lines of stator magnetic field flux 20 creating the magnetic force driving rotor rotation.

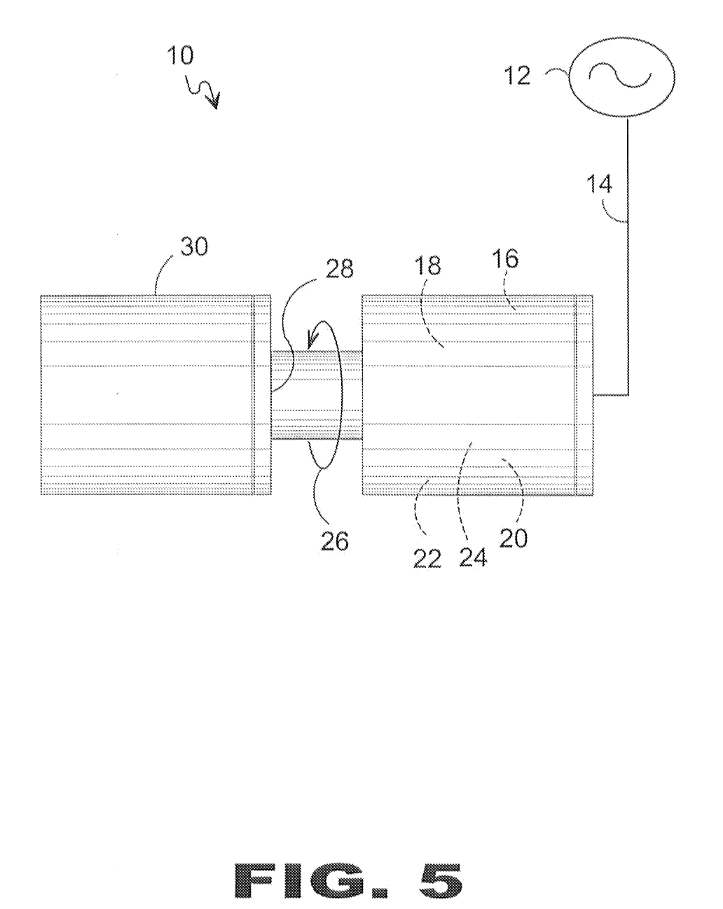

Referring to FIG. 5, shown is the present invention's induction motor. The motor of the present invention 10 has stator 16 with electro-magnets that when energized from an AC power source 12 induces current in rotor 18. The present invention 10 provides that primary rotor 24 rotation 26 derived from the stator's 22 number of electromagnets and AC frequency is impinged upon conjoined stator 32 by virtue of joining 28 rotor 24 and conjoined-stator 32.

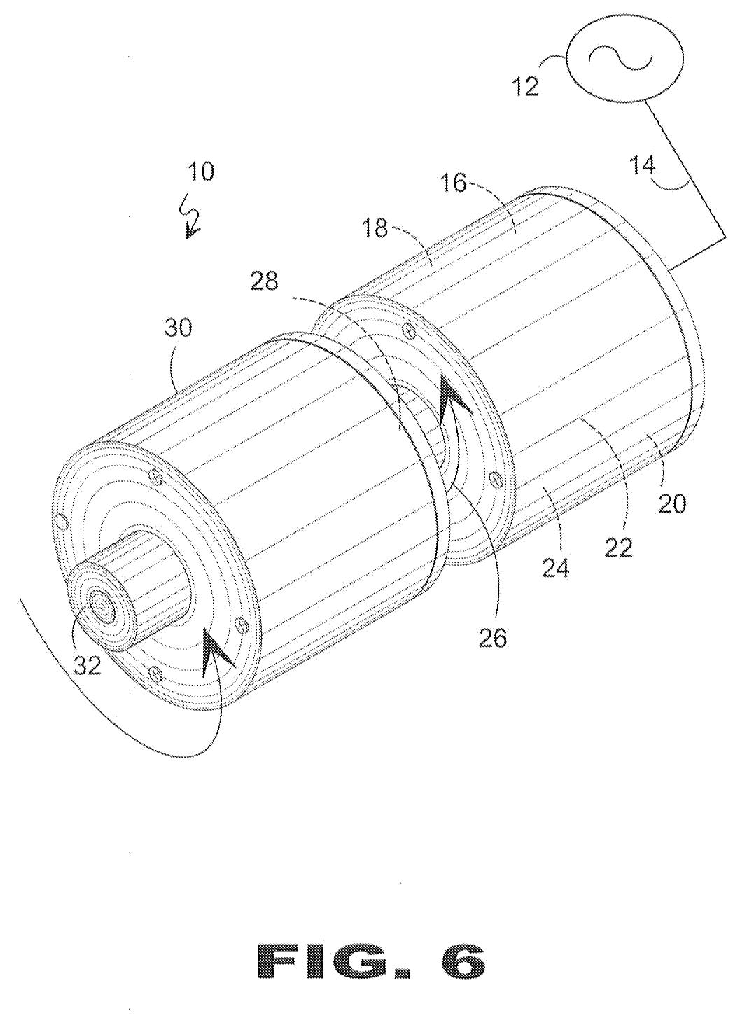

Referring to FIG. 6, shown is the present invention's induction motor. The motor of the present invention 10 has stator 16 with electro-magnets that when energized from an AC power source 12 induces current in rotor 18. The present invention 10 provides that primary rotor 24 rotation 26 derived from the stator's 22 number of electromagnets and AC frequency is impinged upon conjoined stator 30 by virtue of joining 28 rotor 24 and conjoined-stator 30 which is impinged on rotor 32.

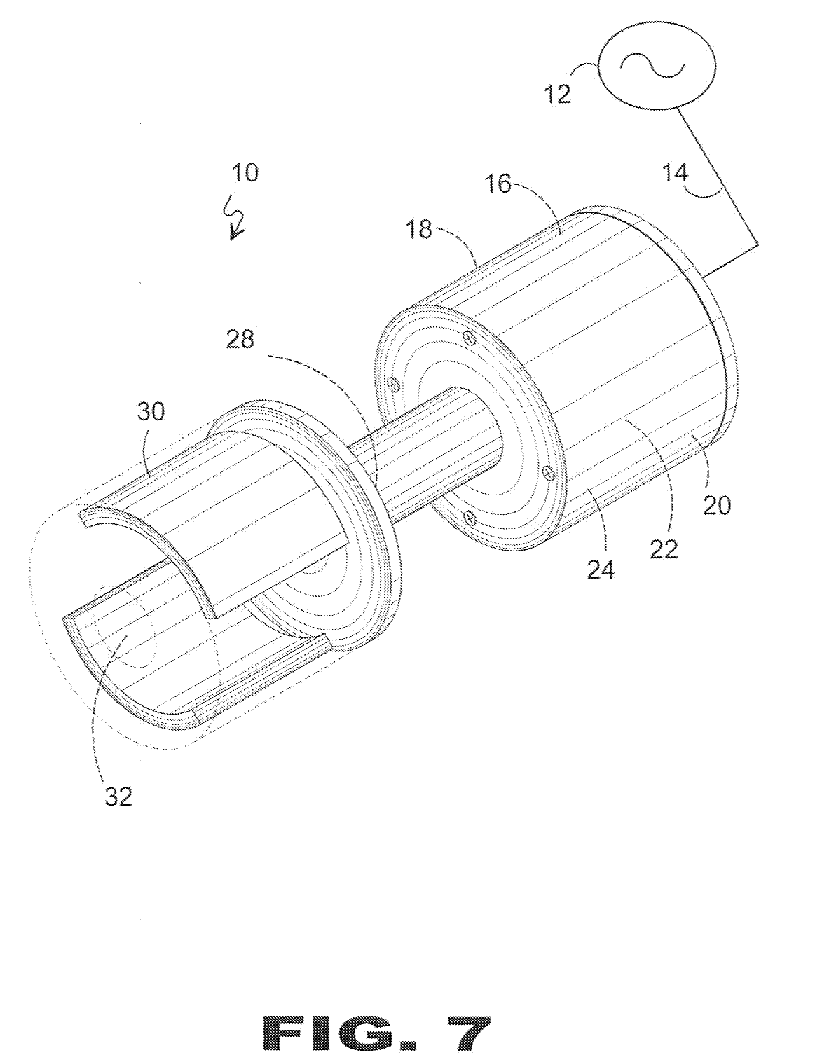

Referring to FIG. 7, shown is the present invention's induction motor. The motor of the present invention 10 provides that primary rotor 24 rotation 26 derived from the stator's 22 number of electromagnets and AC frequency is impinged upon conjoined stator 30 by virtue of joining 28 rotor 24 and conjoined-stator 30 which is impinged on rotor 32.

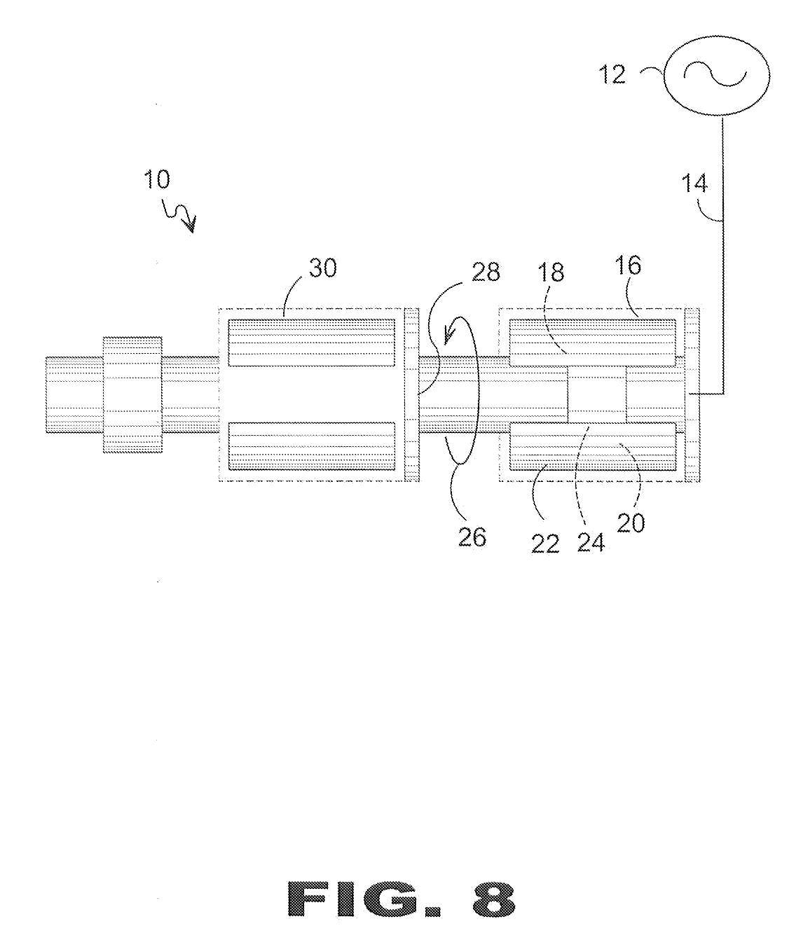

Referring to FIG. 8, shown is the present invention's induction motor. The motor of the present invention 10 has stator 16 which electro-magnets that when energized from an AC power source 12 induces current in rotor 18. The present invention 10 provides that primary rotor 24 rotation 26 derived from the stator's 22 number of electromagnets and AC frequency is impinged upon conjoined stator 30 by virtue of joining 28 rotor 24 and conjoined-stator 30 which is impinged on rotor 32.

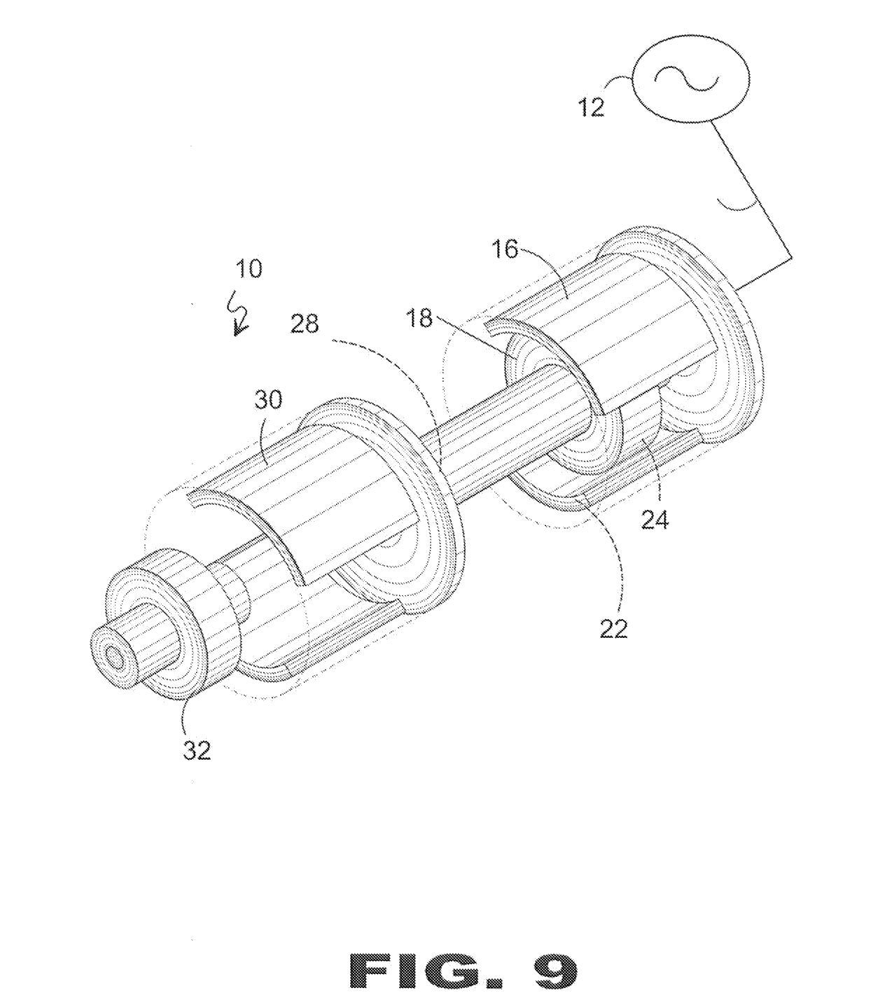

Referring to FIG. 9, shown is the present invention's induction motor. The motor of the present invention 10 having stator 16 comprised of radially positioned electro-magnets that when supplied with AC power 14 from an AC power source 12 are used to create a rotating magnetic field which induces current in rotor 18 conductors which in turn creates conductor magnetic fields that cut lines of stator magnetic field flux 20 creating the magnetic force driving rotor rotation which is impinged on a second stator conjoined with rotor.

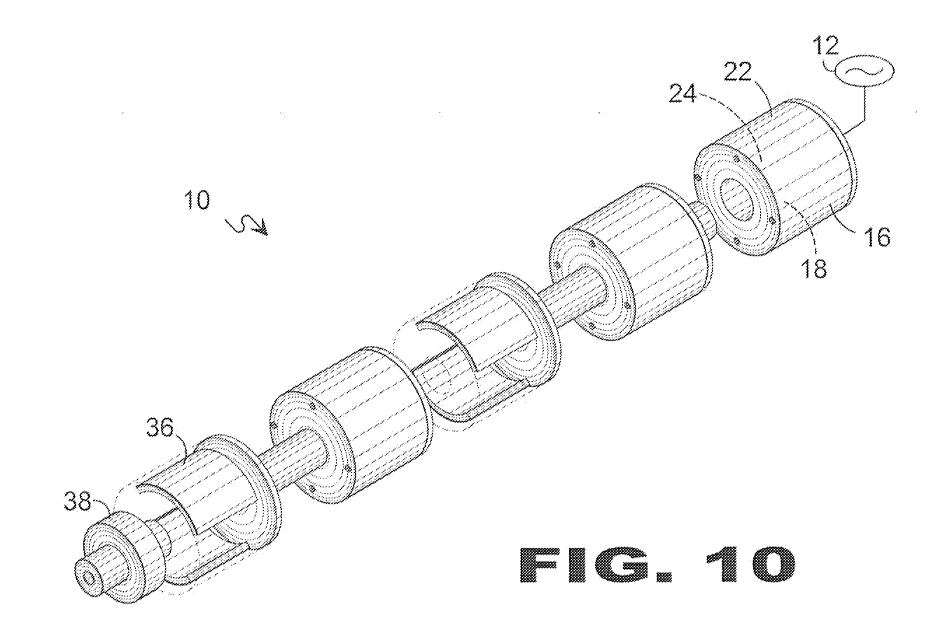

Referring to FIG. 10, shown is the present invention's induction motor. As illustrated, the present invention 10 provides that a primary rotor 24 rotation 26 derived from the stator's 22 number of electromagnets and AC frequency is impinged upon conjoined stator 32 by virtue of joining 28 rotor 24 and conjoined-stator 32 having a rotor rotation that is impinged on an adjoining stator 36 impinging all prior rotation in a cumulative effect which is impinged on the last rotor 38.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by letters patent is set forth in the appended claims.

1. A method and apparatus for increasing induction motor revolutions per minute (RPM), said apparatus comprising:
a) a motor having a selectively continuous source of AC power;
b) said motor having a stator for inducing current within a rotor using said AC current; and
c) said rotor conjoined to a second stator for impinging rotor rotation to said second stator.

2. The apparatus of claim 1, further comprising a conjoined-stator rotor having additive RPM's from the conjoined rotating stator.

3. The apparatus of claim 3, wherein the conjoined-stator rotor has a combined RPM derive from the addition of the RPM's of the source rotor and the RPM's induced by the conjoined-stator.

4. The apparatus of claim 4, wherein a plurality of conjoined-stator rotors configuration results in an additive RPM from the source rotor through the last conjoined-stator.

5. The apparatus of claim 2, wherein the conjoined-stator rotor is conjoined to another stator in step fashion for a plural configuration of conjoined stator rotors defining the apparatus of the present invention whereby each preceding rotor rotation is impinged on the subsequent stator resulting in additive rotor RPM's.

6. The method of providing additive rotor rotation comprising:
a) providing a source of AC current;
b) providing a stator connected to said current;
c) having at least one induction rotor conjoined to an adjacent stator; and
d) said adjacent stator having an induction rotor with the impinged additive rotation of the conjoined stator thereon.
